(19) United States
(12) Patent Application Publication
(10) Pub. No.: US 2008/0002668 A1
(43) Pub. Date: Jan. 3, 2008

(54) PORTABLE COMMUNICATION DEVICE AND METHOD FOR SIMULTANEOUSLY

(75) Inventors: Ram Asokan, Cary, NC (US); Seneca Meyer, Garner, NC (US); Gary Cole, Cary, NC (US); Mohammed T. Ansari, Pleasanton, CA (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/770,801

(22) Filed: Jun. 29, 2007

Related U.S. Application Data
(60) Provisional application No. 60/806,361, filed on Jun. 30, 2006.

(51) Int. Cl. H04L 12/66

(52) U.S. Cl. 370/352

(57) ABSTRACT

A portable communication device and associated method of simultaneously engaging in a circuit-switched communication session and a packet-switched communication session are provided. The method includes receiving circuit-switched audio associated with the circuit-switched communication session and receiving packet-switched audio associated with a packet-switched communication session, wherein at least a portion of the packet-switched audio is received simultaneously with a portion of the circuit-switched audio. The simultaneously received circuit-switched audio and packet-switched audio are selectively presented to a user.

### RELATED APPLICATION DATA

The present application claims the benefit of U.S. Provisional Application Ser. No. 60/806,361, filed Jun. 30, 2006, the disclosure of which is herein incorporated by reference in its entirety.

### TECHNICAL FIELD OF THE INVENTION

The present invention relates generally to portable communication devices, and, more particularly, to a portable communication device and method for simultaneously handling circuit-switched audio and push-to-talk over cellular (PoC) packet-switched audio.

### DESCRIPTION OF RELATED ART

Portable communication devices, such as mobile phones, personal digital assistants, mobile terminals, etc., continue to grow in popularity. As the popularity of portable communication devices continues to grow, today's wireless landscape is rapidly changing as mobile phones and networks are being enhanced to provide services beyond voice services. The wireless industry is experiencing a rapid expansion of mobile data services and enhanced functionality. In addition, the features associated with certain types of portable communication devices have become increasingly diverse. To name a few examples, may portable communication devices have text messaging capability, Internet browsing functionality, e-mail capability, video playback capability, audio playback capability, image display capability and hands-free capability.

In recent years, various cellular telephone systems have implemented capabilities for supporting additional types of communication and data services. By way of example, cellular systems that operate under the GSM standard may provide various packet-switched communications services that may be implemented according to the General Packet Radio Service (GPRS) standards that are part of the GSM standard. Such packet-switched communications services may include e-mail, web browsing, instant messaging and the like.

Another communication capability that is growing in popularity is “push-to-talk” (PTT) capability. Push-to-talk refers to a “walkie-talkie” like feature where two users or a group of users may engage in instant communications. Once a PTT communications session is established, participants in the session typically do not need to dial a phone number to converse with other participants. The communications session may be left open for extended periods of time, even if the participants are in a stand-by mode (e.g., not actually conversing). When a participant chooses to converse with another participant of the PTT session, they typically need only push and hold a button on their portable communication device and speak into the microphone.

There is a movement toward so-called “combinational services,” which allow users to handle multiple services simultaneously, such as a packet-switched service with an ongoing circuit-switched service. For example, a user can be on a circuit-switched voice call while browsing the Internet through a packet-switched session. Similarly, a user might want to engage in a packet-switched PTT communications session while on a circuit-switched voice call. This type of combinational functionality is feasible with the support at the lower layers of the present radio networks, such as UMTS (Universal Mobile Telecommunications System) and GSM (Global System for Mobile Communications) with DTM (Dual Transfer Mode) support. A problem may arise when a user's portable communication device is presented simultaneously with audio from multiple communication sessions. Presently, this is handled by the call-hold feature, but this only allows a user to switch between two services, rather than engage in two services simultaneously.

### SUMMARY

In view of the foregoing, a need exists for a portable communication device and method for simultaneously handling circuit-switched audio and packet-switched audio to facilitate use of combinational services.

One aspect of the invention relates to a portable communication device that includes a circuit-switched communication circuit, which transmits and/or receives circuit-switched audio associated with a circuit-switched communication session, a packet-switched communication circuit, which transmits and/or receives packet-switched audio associated with a packet-switched communication session, and a combination audio processor, which processes simultaneously received circuit-switched audio and packet-switched audio.

According to another aspect, the combination audio processor selectively presents the simultaneously received circuit-switched audio and packet-switched audio to a user of the portable communication device.

According to another aspect, the combination audio processor mixes the circuit-switched audio and the packet-switched audio and plays the mixed circuit-switched and packet-switched audio.

According to another aspect, the circuit-switched audio and packet-switched audio are mixed at different volumes in accordance with user-defined volume levels.

According to another aspect, the portable communication device includes at least two speakers, and the combination audio processor routes the circuit-switched audio through a first speaker and the packet-switched audio through a second speaker.

According to another aspect, the circuit-switched audio and the packet-switched audio are routed through the first and second speakers at different volumes.

According to another aspect, the packet-switched audio is converted to text and visually presented to the user.

According to another aspect, the combination audio processor temporarily stores the packet-switched audio.

According to another aspect, the combination audio processor plays the temporarily stored packet-switched audio at a time when no circuit-switched audio is being received.

According to another aspect, the packet-switched communication session is a push-to-talk (PTT) communication session and the circuit-switched communication session is a voice call.

According to another aspect, the portable communication device is a mobile telephone.

Another aspect of the invention relates to a method of simultaneously engaging in a circuit-switched communication session and a packet-switched communication session. The method includes receiving circuit-switched audio associated with the circuit-switched communication session, receiving packet-switched audio associated with a packet-switched communication session, wherein at least a portion of the packet-switched audio is received simultaneously with a portion of the circuit-switched audio, and selectively presenting to a user the simultaneously received circuit-switched audio and packet-switched audio.

According to another aspect, selectively presenting includes mixing the circuit-switched audio and the packet-switched audio and presenting mixed audio to the user.

According to another aspect, the mixing includes mixing the circuit-switched audio and the packet-switched audio at different volumes in accordance with user-defined volume levels.

According to another aspect, selectively presenting includes routing the circuit-switched audio to a first speaker and routing the packet-switched audio to a second speaker.

According to another aspect, selectively presenting includes converting the packet-switched audio to text and visually presenting the text to the user.

According to another aspect, selectively presenting includes temporarily storing the received packet-switched audio and playing the temporarily stored packet-switched audio at a time when no circuit-switched audio is being received.

Another aspect of the invention relates to a program stored on a machine readable medium, the program being suitable for use in a portable communication device. When the program is loaded in memory in the portable communication device and executed, the program causes the portable communication device to selectively present to a user simultaneously received circuit-switched audio associated with a circuit-switched communication session and packet-switched audio associated with a packet-switched communication session.

According to another aspect, the program causes the portable communication device to mix the circuit-switched audio and the packet-switched audio and present the mixed audio to a user.

According to another aspect, the program causes the portable communication device to route the circuit-switched audio to a first speaker and route the packet-switched audio to a second speaker.

According to another aspect, the program causes the portable communication device to convert the packet-switched audio to text and visually present the text to the user.

According to another aspect, the program causes the portable communication device to store temporarily the received packet-switched audio and play the temporarily stored packet-switched audio at a time when no circuit-switched audio is being received.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a communication system that including a portable communication device that supports combinational services on which aspects of the present invention are carried out;

FIG. 2 is a diagrammatic illustration of a portable communication device in accordance with an embodiment of the present invention;

FIG. 3 is a flow chart or diagram representing a method of the relevant operation of a portable communication device in accordance with an embodiment of the present invention;

FIG. 4 is a flow chart or diagram representing the relevant operation of a portable communication device in accordance with another embodiment of the present invention;

FIG. 5 is a flow chart or diagram representing the relevant operation of a portable communication device in accordance with another embodiment of the present invention; and

FIG. 6 is a flow chart or diagram representing the relevant operation of a portable communication device in accordance with another embodiment of the present invention.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Described herein is a portable communication device and method for simultaneously engaging in a circuit-switched communication session, e.g., a circuit-switched voice call, and a packet-switched communication session, e.g., a push-to-talk (PTT) communication session. Simultaneous engagement in circuit-switched communication services and packet-switched communication services sometimes is referred to as “combinational services.” As is described more fully below, the device and method described herein facilitates selective transmission of audio to one or both of the circuit-switched communication session and the packet-switched communication session. Also, the device and method described herein facilitates selectively presenting to the device user audio (sometimes simultaneously received audio) from the circuit-switched communication session and the packet-switched communication session.

As used herein, the term “portable communication device” includes portable radio communication equipment. The term “portable radio communication equipment”, which herein after may be referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment capable of being used in connection with circuit-switched communication services and packet-switched communication services.

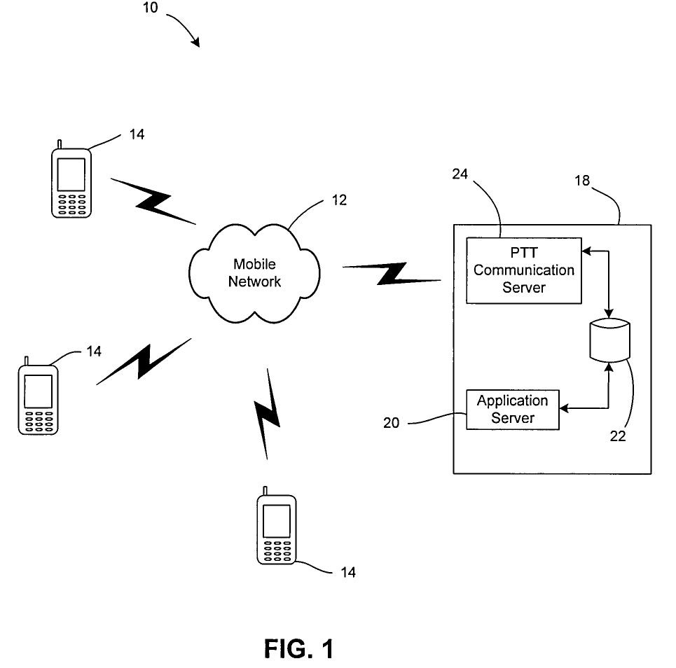

Referring initially to FIG. 1, a communication system 10 includes a mobile network 12, such as a mobile cellular telephony network, that facilitates communication, such as voice communication and/or data transfer between a plurality of portable communication devices 14 such as mobile phones, mobile terminals or the like. The communication system 10 and at least two of the portable communication devices 14, 16 support circuit-switched communications services as well as packet-switched communications services, e.g., push-to-talk (PTT) communications (sometimes referred to as push-to-talk over cellular (PoC)). For purposes of the discussion contained herein, portable communication device 14 will be described in terms engaging in a packet-switched PTT communication session in combination with a circuit-switched voice call. However, it will be appreciated that the method and device described herein are not limited to this particular combination of circuit-switched and packet-switched communication services. Rather, the method and device described herein are applicable to any combination of circuit-switched and packet-switched communication services where the portable communication device may (at least occasionally) simultaneously receives circuit-switched audio and packet-switched audio.

The communication system 10 includes a network infrastructure 18, portions of which are used or otherwise accessed by the portable communication devices in connection with aspects of the invention. The portable communication devices 14 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Voice-Over IP (VoIP), Session Initiated Protocol (SIP), Wireless Local Area Network (WLAN) or the like. In other words, the communication system, including mobile network 12, is shown in FIG. 1 for purposes of explaining aspects of the present invention, without limiting the invention to a particular communication system design, architecture or communication standard.

The network infrastructure 18 includes one or more application servers, which are indicated generally by the numeral 20, and a storage device 22, such as a memory for storing data accessible or otherwise usable by the application servers 18. In the exemplary embodiment described herein, at least one of the application servers is a push-to-talk (PTT) communication server 24. Of course, one or more other application servers may be employed for providing other packet-switched communication services. The application servers 20, including the PTT communication server 24, are computer servers that serve different functions in the communication system. As is described more fully below, one or more of the portable communication devices 14 are operable to engage simultaneously in circuit-switched communications and packet-switched communications involving the receipt (sometimes simultaneous receipt) of circuit-switched audio and packet-switched audio.

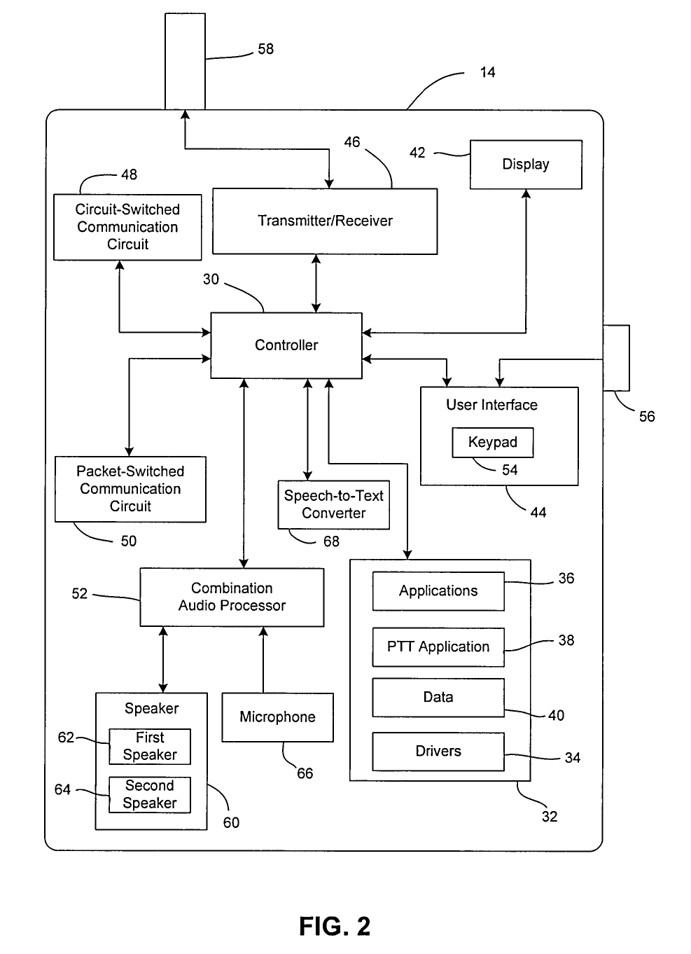

FIG. 2 represents a functional block diagram of a portable communication device 14 in accordance with aspects of the present invention. The portable communication device 14 includes a controller 30 for controlling the overall operation of the portable communication device. The controller 30 may be any commercially available or custom microprocessor. Memory 32 is operatively connected to the processor 30 for storing control programs and data used by the portable communication device. The memory 32 is representative of the overall hierarchy of memory devices containing software and data used to implement the functionality of the portable communication device in accordance with aspects of the present invention.

In the illustrated embodiment, memory 32 stores device drivers 34, e.g., I/O device drivers, application programs, indicated generally by reference numeral 36, including a push-to-talk (PTT) application program 38 (also referred to as a PTT processor), and application program data 40. The I/O device drivers include software routines that are accessed through the processor 30 (or by an operating system (not shown) stored in memory 32) by the application programs 36, including the PTT application program 38, to communicate with devices such as the display 42 and other input/output ports. Of course, the portable communication device may include one or more other application programs for providing packet-switched communication services.

The application programs 36, including the PTT application program 38, comprise programs that implement various features of the portable communication device 14, such as e-mail, Internet access, contact manager and the like. As is discussed more fully below, the PTT application program 38 comprises a program that facilitates engaging in PTT communications, while simultaneously engaging in a circuit-switched communication session, e.g., a circuit-switched voice call.

A person having ordinary skill in the art of computer programming, and specifically in applications programming and/or circuit design for mobile phones, will consider it obvious in view of the description provided herein how to program or otherwise to provide circuitry enabling a mobile phone to operate and carry out the functions described herein with respect to the simultaneous handling of audio from a circuit-switched communication session and audio from a packet-switched communication session. Accordingly, details as to specific programming code and/or circuit implementation have been left out for the sake of brevity. Also, while the PTT communications functionality, including the simultaneous handling of audio from circuit-switched and packet-switched communication sessions, is carried out via the controller 30, the PTT application program 38 (alone or in conjunction with other application programs) and/or the combination audio processor 52 (which is described more fully below) in accordance with aspects of the invention, such function could also be carried out via dedicated hardware, firmware, software or combinations thereof without departing from the scope of the present invention.

With continued reference to FIG. 2, the controller 30 interfaces with the display 42, a user interface unit 44, a transmitter/receiver 46 (often referred to as a transceiver), a circuit-switched communication circuit 48, a packet-switched communication circuit 50 and a combination audio processor 52, e.g., an audio processing circuit. In the illustrated embodiment, the user interface unit 44 includes or is operatively coupled to a keypad 54 and a PTT actuator 56, e.g., a button used to initiate PTT functions, such as initiating a PTT communication session, taking control of the floor and the like, during a typical PTT communication session. While the PTT actuator 56 is depicted as a separate and dedicated user interface button, it will be appreciated that other existing buttons or keys on the mobile phone, e.g., one or more of the keys within the keypad 54 (so-called “soft keys), may be employed to provide the PTT functionality. In other words, the present invention is not intended to be limited to any particular configuration or geometry of PTT actuators.

The display 42, keypad 54 and the PTT actuator 56 provided are part of a user interface unit 44 that allows the user to interact with the mobile phone 14. For example, keypad 54 allows the user to dial numbers, enter commands and data, and select options. The display 42 allows the user to view a variety of information, such as dialed digits, stored information, and output from various applications, including the PTT application program 38. As is discussed more fully below, the PTT actuator 56 allows a user to initiate a PTT session, e.g., inviting one or more other users to participate in a PTT communications session, and/or take control of the floor for speaking during the PTT communications session, in response to or otherwise based on silent call pacing signals provided by the mobile phone.

As is described below, in the case of combinational services that include a simultaneous circuit-switched communication session and a packet-switched communication session, the PTT actuator 56 may also serves to indicate through which application/communication service to route voice from the user of the portable communication device. For example, when the user is not pushing or otherwise engaging the PTT actuator 56, the user's voice will be routed through the circuit-switched communication application/service, a circuit-switched voice call. When the user is pushing or otherwise engaging the PTT actuator, the user's voice will be routed through the packet-switched communication application/service, e.g., a PTT communication session.

An antenna 58 is coupled to the transmitter/receiver 46 such that the transmitter/receiver 46 transmits and receives signals via the antenna 58, as is conventional. The portable communication device 14 includes a combination audio processor 52 for processing audio signals, including simultaneously received circuit-switched audio signals associated with a circuit-switched communication session and packet-switched audio associated with a packet-switched communication session.

As is described more fully below, the combination audio processor handles simultaneously received circuit-switched and packet-switched audio according to one or more methodologies for selectively presenting to a user the simultaneously received circuit-switched and packet-switched audio. Coupled to the combination audio processor 52 is a speaker unit 60, e.g., a stereo speaker unit (such as may be included in a stereo headset), including a first speaker 62 and a second speaker 64, and a microphone 64, which enable the user to listen and speak via the portable communication device. Optionally, the portable communication device includes a speech-to-text converter 68 that is operable to convert received audio into a text format for graphical display for the user. In the illustrated exemplary embodiment, the speech-to-text converter 68 is on or otherwise stored within the portable communication device. Alternatively, a speech-to-text converter may reside in one or more application servers on the mobile network.

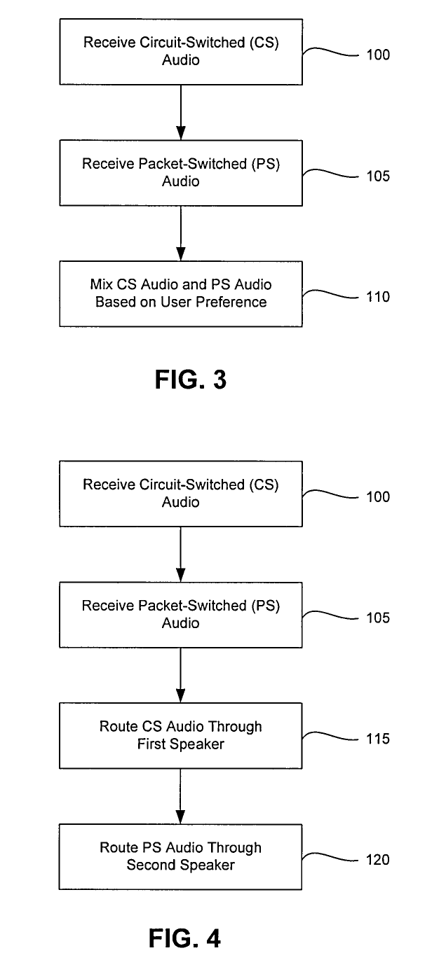

While for purposes of simplicity of explanation, the flow charts or diagrams in FIG. 3-FIG. 6 include a series of steps or functional blocks that represent one or more aspects of the relevant operation of the portable communication device 14, it is to be understood and appreciated that aspects of the present invention are not limited to the order of steps or functional blocks, as some steps or functional blocks may, in accordance with aspects of the present invention, occur in different orders and/or concurrently with other steps or functional blocks from that shown and described herein. Moreover, not all illustrated steps or functional blocks of aspects of the relevant operation may be required to implement a methodology in accordance with an aspect of the invention. Furthermore, additional steps or functional blocks of aspects of relevant operation may be added without departing from the scope of the present invention.

Turning now to FIG. 3, a method of simultaneously receiving circuit-switched audio associated with a circuit-switched communication session and packet-switched audio associated with a packet-switched communication session is provided. The illustrated method or functionality begins at functional block 100 where circuit-switched audio, e.g., voice audio associated with a circuit-switched voice call is received. At functional block 105, packet-switched audio, e.g., audio associated with a packet-switched communication session, such as a push-to-talk (PTT) communication session (sometimes referred to as a PTT over cellular or PoC session), is received.

In this embodiment, the combination audio processor selectively presents the simultaneously received circuit-switched (CS) audio and the packet-switched (PS) audio to the user by mixing the circuit-switched audio to the user by mixing the circuit-switched audio and the packet-switched audio based on one or more user-defined preferences. For example, the CS audio and the PS audio may be mixed with different volume levels as set or otherwise predefined by the user. For example, the user may indicate that the CS audio should be played at a relatively lower volume level with respect to the PS audio (in the case of PTT communications, the rather intermittent and bursty audio associated with the PS communication session). Alternatively, the user may indicate a preference for the CS audio to be played or otherwise presented at a volume that is greater than the volume of the PS audio.

With reference now to FIG. 4, another embodiment of a method of simultaneously receiving CS audio and PS audio begins at functional block 100 where CS audio, e.g., voice audio associated with a CS voice call, is received at least partially simultaneously with PS audio, e.g., audio associated with a PTT communication session, at functional block 105. In this embodiment, the portable communication device will be described by having at least two speakers, such as in a so-called stereo handset or stereo headset. At functional block 115, the CS audio is routed through the first speaker and played to the user, e.g., played to the user in the user's left ear in the case of a stereo headset. At approximately the same time, at functional block 120, the PS audio is routed or otherwise presented to the user through the second speaker, e.g., played to the user in the user's right ear through the stereo headset. The volume of the separately routed CS audio and PS audio may be different or otherwise adjusted depending on user-defined preferences. For example, the user may want the audio coming through the left ear speaker to be louder than the audio coming through the right ear speaker.

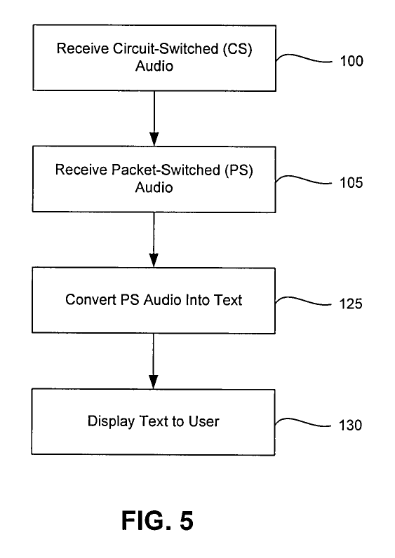

FIG. 5 depicts another method of simultaneously receiving CS audio and PS audio that begins at functional block 100 where the CS audio, e.g., CS voice call audio, is received (at least partially) simultaneously with PS audio, e.g., PTT communication session audio, at functional block 105. At functional block 125, the received PS audio is converted to text, typically using a speech-to-text converter application present either on the portable communication device or present on the network, e.g., on the application server providing the speech-to-text functionality. In a preferred embodiment, the PS audio only will be converted to text, when it is received simultaneously or near simultaneously with CS audio. Alternatively, the user may select or otherwise define that all PS audio be converted to text regardless of whether or not the PS audio is received simultaneously or nearly simultaneously with the CS audio. At functional block 130, the text representative of the converted PS audio is displayed to the user.

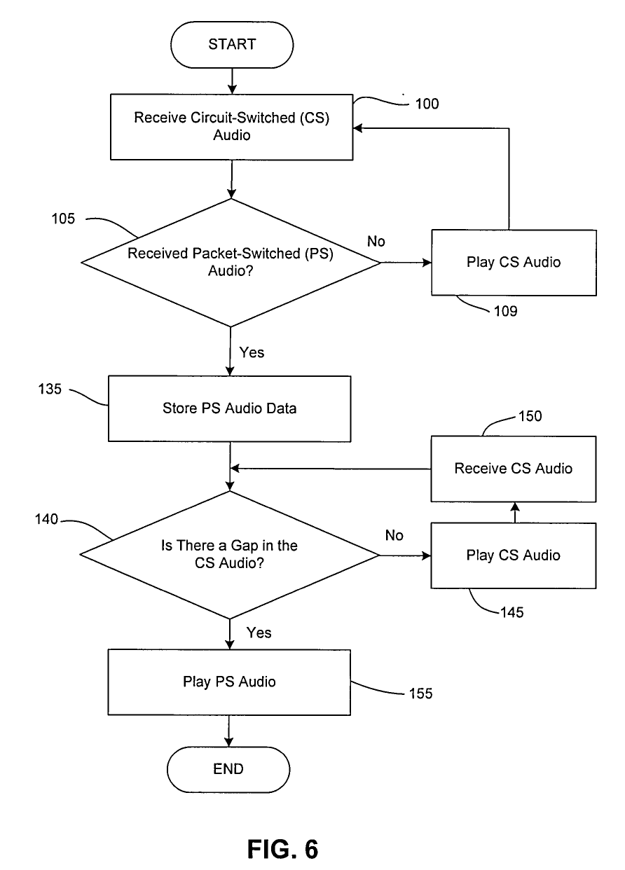

FIG. 6 depicts a method of simultaneously receiving or otherwise handling simultaneously received CS audio and PS audio that begins at step 100 where CS audio, e.g., CS voice call audio, is received at functional block 100. At functional block 105, the portable communication device determines whether any PS audio has been received simultaneously, nearly simultaneously with or otherwise overlapping with the received CS audio. If it is determined that no PS audio has been or is being received simultaneously, nearly simultaneously with or otherwise overlapping with the received CS audio, the portable communication device will play the CS audio at functional block 109 (and continue to receive any transmitted CS audio (functional block 100).

If it is determined that PS audio is being received simultaneously, nearly simultaneously or otherwise overlapping with the receipt of CS audio, the received PS audio data is stored in an appropriate memory location at functional block 135. It will be appreciated that this PS audio, e.g., audio associated with a PTT communication session, will be stored until an appropriate time when it can be presented to the user without conflicting with the CS audio. At step 140, the portable communication device determines whether there is a gap in the received CS audio. If or while no gap in the CS audio is detected, the portable communication device will play the CS audio (functional block 145) and continue to receive any transmitted CS audio (functional block 150). If a gap in the received CS audio is detected, e.g., a gap in CS voice call audio as is the case during a normal conversation between two voice call participants, the PS audio is played for the user at functional block 155.

It will be appreciated that a portable communication device having the functionality to simultaneously handle CS audio and PS audio facilitates use combinational services that include (sometimes simultaneously received) CS audio and PS audio in a seamless or near-seamless manner. This may be especially useful in the case of a combinational service including a CS-based voice call and a PS-based PTT communication session, where the CS-based voice data is relatively steady while the PS-based PTT audio often is intermittent and bursty. Of course, as is mentioned above, aspects of the present invention that are described herein are not intended to be limited to PS audio associated with PTT communication sessions. Rather, CS audio of any sort may be received and handled together with PS audio resulting from any suitable PS communication service, including, but not limited to streaming audio, streaming video, web browsing that includes received audio and the like. In addition, it will be appreciated that aspects of the invention described herein may find application in conjunction with handling audio from multiple sources where some overlap or near overlap in the audio is present. For example, a user may be on a CS-based voice call and simultaneously watching a video clip on the portable communication device. In this exemplary application or combinational service, the portable communication device may use one or more of the methodologies described herein to handle simultaneously presented CS audio and PS audio.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a circuit-switched communication circuit that transmits and/or receives circuit-switched audio associated with a circuit-switched communication session;
a packet-switched communication circuit that transmits and/or receives packet-switched audio associated with a packet-switched communication session; and
a combination audio processor that processes simultaneously received circuit-switched audio and packet-switched audio.

2. The portable communication device according to claim 1, wherein the combination audio processor selectively presents the simultaneously received circuit-switched audio and packet-switched audio to a user of the portable communication device.

3. The portable communication device according to claim 2, wherein the combination audio processor mixes the circuit-switched audio and the packet-switched audio and plays the mixed circuit-switched and packet-switched audio.

4. The portable communication device according to claim 3, wherein the circuit-switched audio and packet-switched audio are mixed at different volumes in accordance with user-defined volume levels.

5. The portable communication device according to claim 2, wherein the portable communication device includes at least two speakers, and the combination audio processor routes the circuit-switched audio through a first speaker and the packet-switched audio through a second speaker.

6. The portable communication device according to claim 5, wherein the circuit-switched audio and the packet-switched audio are routed through the first and second speakers at different volumes.

7. The portable communication device according to claim 2, wherein the packet-switched audio is converted to text and visually presented to the user.

8. The portable communication device according to claim 2, wherein the combination audio processor temporarily stores the packet-switched audio.

9. The portable communication device according to claim 8, wherein the combination audio processor plays the temporarily stored packet-switched audio at a time when no circuit-switched audio is being received.

10. The portable communication device according to claim 2, wherein the packet-switched communication session is a push-to-talk (PTT) communication session and the circuit-switched communication session is a voice call.

11. The portable communication device according to claim 1, wherein the portable communication device is a mobile telephone.

12. A method of simultaneously engaging in a circuit-switched communication session and a packet-switched communication session, the method comprising:
receiving circuit-switched audio associated with the circuit-switched communication session;
receiving packet-switched audio associated with a packet-switched communication session, wherein at least a portion of the packet-switched audio is received simultaneously with a portion of the circuit-switched audio; and
selectively presenting to a user the simultaneously received circuit-switched audio and packet-switched audio.

13. The method according to claim 12, wherein selectively presenting includes mixing the circuit-switched audio and the packet-switched audio and presenting mixed audio to the user.

14. The method according to claim 13, wherein the mixing includes mixing the circuit-switched audio and the packet-switched audio at different volumes in accordance with user-defined volume levels.

15. The method according to claim 12, wherein selectively presenting includes routing the circuit-switched audio to a first speaker and routing the packet-switched audio to a second speaker.

16. The method according to claim 12, wherein selectively presenting includes converting the packet-switched audio to text and visually presenting the text to the user.

17. The method according to claim 12, wherein selectively presenting includes temporarily storing the received packet-switched audio and playing the temporarily stored packet-switched audio at a time when no circuit-switched audio is being received.

18. A program stored on a machine readable medium, the program being suitable for use in a portable communication device, wherein when the program is loaded in memory in the portable communication device and executed causes the portable communication device to:
selectively present to a user simultaneously received circuit-switched audio associated with a circuit-switched communication session and packet-switched audio associated with a packet-switched communication session.

19. The program according to claim 18, wherein the program causes the portable communication device to mix the circuit-switched audio and the packet-switched audio and present the mixed audio to a user.

20. The program according to claim 18, wherein the program causes the portable communication device to route the circuit-switched audio to a first speaker and route the packet-switched audio to a second speaker.

21. The program according to claim 18, wherein the program causes the portable communication device to convert the packet-switched audio to text and visually present the text to the user.

22. The program according to claim 18, wherein the program causes the portable communication device to store temporarily the received packet-switched audio and play the temporarily stored packet-switched audio at a time when no circuit-switched audio is being received.
